(19) United States
(12) Patent Application Publication
(10) Pub. No.: US 2020/0017024 A1
(43) Pub. Date: Jan. 16, 2020

(54) MAGNETIC LED WARNING ARROW SIGN

(71) Applicant: Ida Mollo, New Orleans, LA (US)

(72) Inventor: Ida Mollo, New Orleans, LA (US)

(21) Appl. No.: 16/035,214

(22) Filed: Jul. 13, 2018

(51) Int. Cl. B60Q 7/02; B60Q 1/46; B60Q 1/30

(52) U.S. Cl. CPC B60Q 7/02; B60Q 1/302; B60Q 1/46

(57) ABSTRACT

A portable lighted arrow sign for removable attachment to a surface of a vehicle is provided. The magnetic plate member has a plurality of light emitting diodes as illuminated members configured to display the shape of the arrow, which directs oncoming traffic away from the vehicle when the magnetic plate member is magnetically connected the surface of the vehicle. The magnetic plate member is characterized as portable in size and configured to be grasped by a user's hand, to maneuver and position the lighted arrow sign upon the surface of the vehicle. The portable lighted arrow sign is preferably characterized as having a length sufficient to extend laterally outwardly from the vehicle in the form of a cantilever, to provide improved warning and direction to oncoming traffic.

### BACKGROUND OF THE INVENTION

### Field of the Invention

The present invention generally relates to lighted signs and more particularly relates to lighted warning signs magnetically attachable to a vehicle surface for notifying oncoming vehicles of danger.

### Description of the Related Art

A car which has run out of gas or is disabled by some other circumstance and is stopped on the shoulder of or in the roadway poses a real danger of causing an accident, since it may not be seen in time, or the situation may not be properly judged by other motorists. A number of safety warning devices have been devised whose purpose is to increase the visibility of the stopped car or to draw attention to it. One such device is disclosed in U.S. Pat. No. 3,255,725 issued to Von Kreidner, in which a sign is rolled up on a spring roller attached to the inner surface of a car's trunk lid and is used with the trunk open and the sign stretched between the lid and latch in the lower part of the trunk. However, use of such a device exposes the contents of the trunk to inclement weather or possible theft should the car be left for an extended time, and is of use only in a limited number of situations, lacking the versatility of the invention hereinafter described.

U.S. Pat. No. 3,949,503 issued to Waress discloses an emergency warning device for a motor vehicle made up of a long, brightly colored plastic sheet with a warning message which is stored on a roller and adapted to be mounted on the inside surface of the trunk lid of the vehicle. In order to warn other motorists of danger or emergency when the vehicle is stopped on a street or highway, the plastic sheet can be displayed by withdrawing it from the roller with the trunk in its open position; or, because of its length, it can be fed through the forward crack between the trunk lid and the vehicle body, brought across the top surface of the trunk and attached to the car, with the trunk closed to protect the contents. The proximity of the message to the bottom end of the sheet enables the message to be visible either when the sheet is partially unrolled or when fully unrolled and stretched over the outer surface of a closed trunk. This device includes moving parts, must be stored on a roller in the trunk, and does not include lighting elements, lacking the versatility and efficacy of the invention disclosed herein.

U.S. Patent Application Publication No. 2011/0219649 by Spann discloses an automobile hazard warning sign. A sign that connects to the car window which can display colors during the day or an electronic programmable sign at night. The back of the display has an insert where owner contact information can be kept if the automobile has to be abandoned due to the vehicle being inoperative. The sign provides automobile owners, highways drivers, and law enforcement with the ability to identify an inoperative vehicle, help the owner of the car, prevent accidents on the highways, understand vehicle problem and help law enforcement contact the owner. However, this invention does not disclose a substantially flat sign that connects to a surface of a vehicle. Rather, a large rectangular box is intended to sit atop a vehicle or be hung from a window.

U.S. Pat. No. 5,315,777 issued to Fogelman discloses a highway emergency safety sign. A foldable emergency sign is provided, made up of a number of flat slats joined by flexible hinges. The slats are provided with warning indicia to alert passing motorists to the presence of a disabled vehicle. The slats are also provided with magnets for quick attachment and detachment from a vehicle. A support harness may be provided for attachment to irregularly shaped areas of a vehicle. The slats may be arranged in two columns with the triangular emergency sign defined over a number of the slats in both columns or the slats may be portions of the sidearms themselves of the triangular emergency sign. While this invention is intended to sit atop the surface of a vehicle, it does not disclose a power source or lighting. Rather, reflective strips are intended attract from the surroundings. Further, the invention uses a series of flat slats, which is disadvantageous when a user desires to show a solid message or display.

U.S. Pat. No. 3,670,438 issued to Carroll, et al., discloses an auto travel trouble sign. Sign means including a plastic sign plate emboss formed of thin sheet plastic and having raised luminescent lettering forming a word for communicating a message of distress or information. The sign means includes a permanent magnet strip fixed to the backside of the sign plate for temporary attachment thereof to the exterior surface of a wrecked or stalled automobile on a highway or thoroughfare. While this invention is intended to magnetically attach to the surface of a vehicle, it does not disclose a power source or lighting. Rather, a reflective coating is intended attract from the surroundings.

U.S. Pat. No. 3,949,503 issued to Waress discloses an emergency warning device. An emergency warning device for a motor vehicle is made up of a long, brightly colored plastic sheet with a warning message which is stored on a roller and adapted to be mounted on the inside surface of the trunk lid of the vehicle. In order to warn other motorists of danger or emergency when the vehicle is stopped on a street or highway, the plastic sheet can be displayed by withdrawing it from the roller with the trunk in its open position; or, because of its length, it can be fed through the forward crack between the trunk lid and the vehicle body, brought across the top surface of the trunk and attached to the car, with the trunk closed to protect the contents. The proximity of the message to the bottom end of the sheet enables the message to be visible either when the sheet is partially unrolled or when fully unrolled and stretched over the outer surface of a closed trunk. This invention requires the use of a roller and to be mounted inside of the surface of the trunk, lacking the versatility of the invention disclosed herein.

U.S. Pat. No. 4,663,874 issued to Sano, et al., discloses a magnetically attachable sign. A flexible magnetic sign, such as may be detachably provided on a body panel of a motor vehicle, in which bulging due to the presence of air or moisture is eliminated. The rear surface of the sign is formed with trough-indentations. This may take the form of parallel stripes, a checkered pattern, indentations having a random orientation, or a textured surface. This invention is directed at ensuring that magnetic signs attached to vehicles remain flat without bulging through the use of a texture, and does not provide a sign utilizing a power source and lighting as disclosed herein.

U.S. Pat. No. 6,955,455 issued to Schneider discloses a magnetically attached sign. A lighted sign for application to a vehicle surface includes first and second metallic layers with a magnetic plate sandwiched therebetween. The second metallic layer includes a circumference smaller than that of the magnetic plate such that it is pressed against a vehicle surface when the magnetic plate is magnetically adhered thereto. A light source is coupled to the magnetic plate with a positive wire connected to the first metallic layer and a negative wire connected to the second layer such that the light source emits light when the first metallic layer is energized by a vehicle electrical power source and is grounded when the second metallic layer is pressed against the vehicle metallic surface. The magnetic plate and first metallic surface include cutouts so that light may be emitted by the light source therethrough. The lighted sign includes a microcontroller and environmental sensors for advanced lighting control. While this sign attaches to a surface of an automobile, the sign is intended to be grounded through the auto body. Thus, the full sign has to be in contact with the auto body while in use, lacking the versatility of only using partial contact as disclosed with the invention herein.

U.S. Pat. No. 5,918,397 issued to Elmer discloses an illuminated magnetic advertising sign. An advertising display for use above the roof of a vehicle comprises a rigid elongated and enclosed advertising member, which is of substantially triangular cross section and which can be reversibly mounted on a metallic roof with the use of magnets affixed within receptacles in the base of the display. Apparatus is provided for storing a plurality of the advertising members in a space-conserving fashion. This substantially triangular design is bulky and is permanently fastened to the roof of a vehicle, lacking the versatility of the invention disclosed herein.

U.S. Pat. No. 9,387,799 issued to Kang discloses a safety sign board system for automobile. A safety sign board system attached to an inner surface of a trunk lid of an automobile comprises an upper casing having a space for receiving a safety sign board and attached to the inner surface of the trunk lid of the automobile, a support coupled with a front portion of the upper casing via a hinge, and the safety sign board shaped as a triangle, having an upper plate and a lower plate attached to each other, and attached to the support via a bolt. A plurality of light emitting diodes (LEDs) or lamps are formed on a surface of the upper plate. This device is intended to sit in a car's trunk and is used with the trunk open. However, use of such a device exposes the contents of the trunk to inclement weather or possible theft should the car be left for an extended time, and is of use only in a limited number of situations, lacking the versatility of the invention hereinafter described.

Therefore, it is an object of the present invention to provide a novel and improved visible warning device for vehicles which can be seen for great distances and will attract the attention of other drivers.

It is another object of this invention to provide a warning device which is readily and quickly accessible.

It is another object of this invention to provide an emergency sign which can be extended from a surface of a car to serve as a visible warning to other motorists.

It is another object of this invention to provide a versatile and portable warning device, which can be used in a multitude of locations and can be hand-held.

It is still another object of the present invention to provide an emergency sign for motor vehicles which is very durable and economical while being made up of a minimum number of parts and can be removably attached to the outer surface of a vehicle.

Over the years, various devices have been made to assist people with warning oncoming motorists of a stalled vehicle. However, such commonly known devices are of complex construction, largely inefficient in operation.

While conventional warning devices may be suitable for the particular purpose employed, they would not be as suitable for the purposes of the present invention as disclosed hereafter.

Accordingly, there is a need for a portable emergency lighted sign to easily and efficiently warn oncoming motorists that can easily be removably attached to a vehicle.

As disclosed in this application, the inventor has discovered novel and unique devices and methods for efficient warnings for motorists, which exhibit superlative properties without being dependent on heavy, immobile, expensive or complex components.

Embodiments of the present invention provide for devices and methods and disclosed herein and as defined in the annexed claims which provide for improved vehicular warning signage.

### SUMMARY OF THE INVENTION

It is one prospect of the present invention to provide one or more novel devices of simple but effective construction which can be applied to many environments to efficiently and effectively notify other vehicles of oncoming danger.

The following presents a simplified summary of the present disclosure in a simplified form as a prelude to the more detailed description that is presented herein.

Therefore, in accordance with embodiment of the invention, there is provided a lighted arrow sign for removable attachment to a surface of a vehicle, having an elongated magnetic plate member for removable magnetic adherence to a surface of a vehicle. The magnetic plate member preferably forms a shape of an arrow. In other embodiments, forming the shape of an arrow includes the shape of a double headed arrow having a first head opposite a second head.

In another embodiment, the magnetic plate member has a plurality of light emitting diodes that display the shape of an arrow, for the direction of oncoming traffic relative to the vehicle, when at least a portion of the magnetic plate member is magnetically connected to the outer surface of the vehicle. Preferably, the magnetic plate member is characterized as having a length sufficient to extend laterally outwardly from said vehicle to form a cantilever, and the cantilever directs oncoming traffic away from said vehicle.

In other embodiments, the lighted arrow sign further comprises a battery and a switch electrically interposed between said battery and said LEDs for powering of said LEDs at the option of the user.

In yet another embodiment, the lighted arrow sign has a magnetic plate member characterized as portable in size and configured to be grasped by a user's hand to maneuver and position the arrow sign upon the surface of the vehicle.

In a preferred embodiment, a portable lighted warning arrow is provided that has an elongated magnetic rod is configured for removable magnetic attachment to a metal surface of a vehicle. The magnetic rod forms the shape of an arrow for the direction of oncoming traffic relative to the vehicle. The magnetic rod has a plurality of light emitting diodes electronically connected to a portable power source. The elongated magnetic rod is configured to cantilever outwardly from the magnetic attachment.

In another embodiment, a battery is electronically connected to the LEDs, and the switch preferably includes the surface of the vehicle, such that the magnetic adherence to the surface of the vehicle continues the flow of electrical energy from the battery to the LEDs, to power the LEDs.

In yet another embodiment, a switch is electrically interposed between the battery and LEDs for powering the LEDs at the option of the user.

In a preferred embodiment, a flexible emergency sign is provided for application to a surface of a vehicle, and the flexible emergency sign has a flexible magnetic substrate comprising an arrangement of light emitting diodes configured in the shape of an arrow.

Where the surface of the vehicle is curved, the flexible magnetic substrate is preferably configured to magnetically attach and conform to the curved surface, at the option of the user. As disclosed in the embodiments herein, the flexible magnetic substrate preferably conforms to the curvature of the surface of the vehicle, at the option of the user.

In one embodiment, a battery is secured to the flexible magnetic substrate. The battery is preferably connected to an underside of the flexible magnetic substrate.

In another embodiment, a switch is electrically interposed between a battery and the LEDs. In other embodiments, the switch comprises the metal surface of the vehicle, and the magnetic attachment to the metal surface of the vehicle continues flow of electrical energy from the battery to the LEDs, to power the LEDs.

In yet another embodiment, a periodical interruption circuit is arranged to discontinue the flow of electrical energy from the battery to the LEDs periodically so as to produce a flashing effect characterized as illustrating the shape of an arrow.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a front view of an exemplary lighted arrow sign for removable attachment to a surface of a vehicle in accordance with embodiments of the invention.

FIG. 2 is a front view of an exemplary portable lighted warning arrow in accordance with embodiments of the invention.

FIG. 3 is a back right perspective view of an exemplary lighted arrow sign for removable attachment to a surface of a vehicle in accordance with an embodiment of the invention, with such exemplary arrow sign magnetically attached to and extending laterally outward from the vehicle to form a cantilever.

FIG. 4A is a back right perspective view of an exemplary lighted arrow sign for removable attachment to a surface of a vehicle in accordance with an embodiment of the invention, said arrow sign magnetically attached to a vehicle.

FIG. 4B is a back right perspective view of another exemplary lighted arrow sign for removable attachment to a surface of a vehicle in accordance with embodiments of the invention, said arrow sign magnetically attached to a vehicle.

FIG. 5 is a back right perspective view of an exemplary portable lighted warning arrow for removable attachment to a surface of a vehicle in accordance with embodiments of the invention, as illustrated as magnetically attached to and extending laterally outward from the vehicle to form a cantilever.

FIG. 6 is a back right perspective view of an exemplary portable lighted warning arrow for removable attachment to a surface of a vehicle in accordance with an embodiment of the invention, as illustrated as magnetically attached to a vehicle.

FIG. 7 is a front view of a flexible emergency sign for application to a surface of a vehicle in accordance with embodiments of the invention.

FIG. 8 is a front view of an exemplary flexible emergency sign for application to a surface of a vehicle showing an exemplary power source, switch, and periodic interruption circuit in accordance with embodiments of the invention.

FIG. 9 is a back right perspective view of an exemplary flexible emergency sign for application to a surface of a vehicle in accordance with an embodiment of the invention, said emergency sign magnetically attached to and wrapping around a corner of vehicle in accordance with an embodiment of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

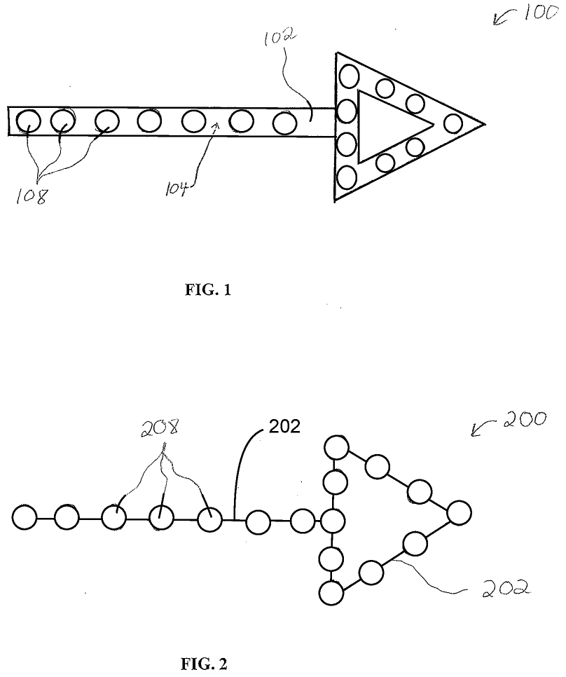

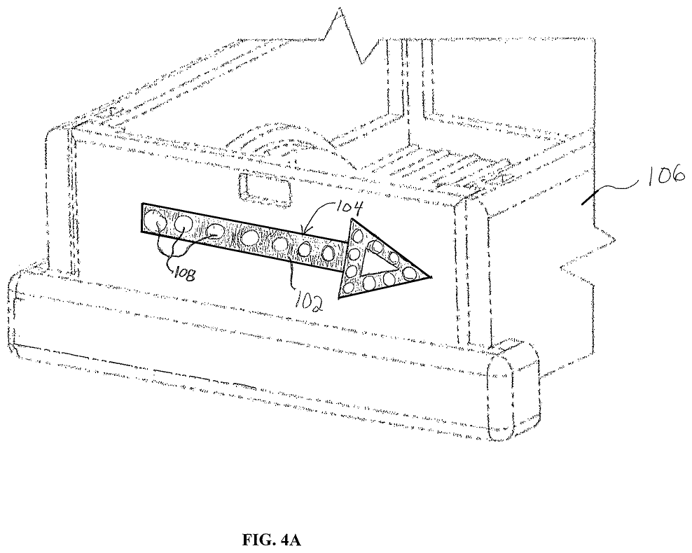

FIGS. 1 through 8 show the basic constructional details and principles of operation of a magnetic LED sign in accordance with preferred embodiments of the invention. FIG. 1 shows a lighted arrow sign 100 for removable attachment to a surface of a vehicle 106. The lighted arrow sign 100 has particular utility in bringing attention to a car which has stalled or is stopped on or near a roadway and cannot be moved. Preferably, an elongated magnetic plate member 102 for removable magnetic adherence 104 to a surface of a vehicle 106. In a preferred embodiment, the magnetic plate member 102 may form a shape of an arrow. The magnetic plate member 102 may include a plurality of light emitting diodes (“LEDs”) 108 as illuminated members. In an alternative embodiment, the illuminated members may be iridescent lights, for example. The LEDs 108 may configured to display a shape, such as an arrow, for the direction of oncoming traffic relative to the vehicle. The lighted arrow sign 100 allows for versatility when attaching to a vehicle 106. A portion of said magnetic plate member may magnetically connected the surface of the vehicle, allowing the remaining portion to extend away from the vehicle 106, providing an extended area as opposed to when the sign 100 is applied in its entirety to the vehicle 106. The lighted arrow sign 100 is preferably made of a light-weight but durable plastic material such as a thermoplastic or olefin material. Other durable plastics may also be used, such as ABS, polypropylene, polycarbonate, or polyethylene plastics which exhibit various degrees of weatherability and durability. As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

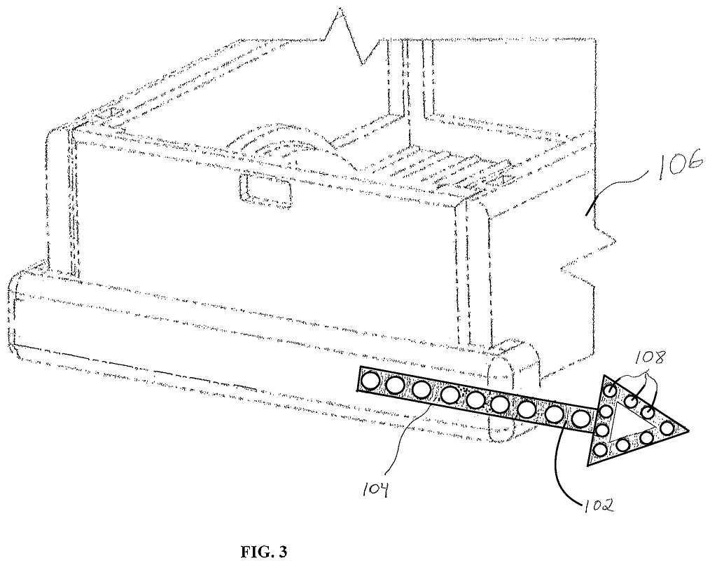

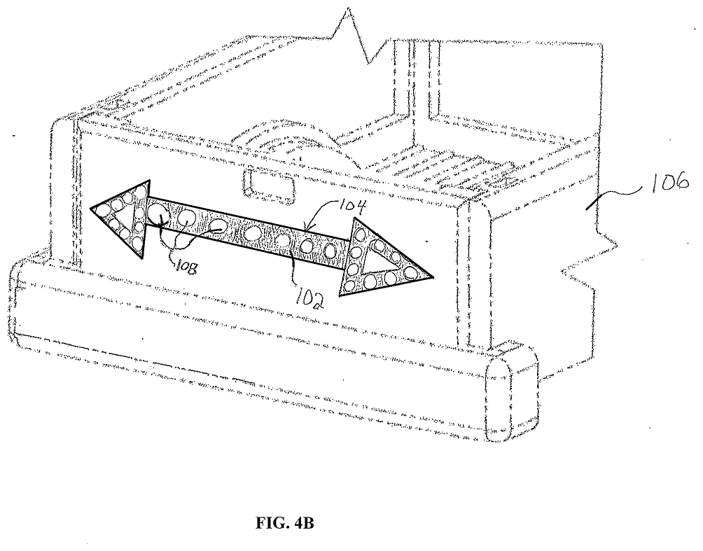

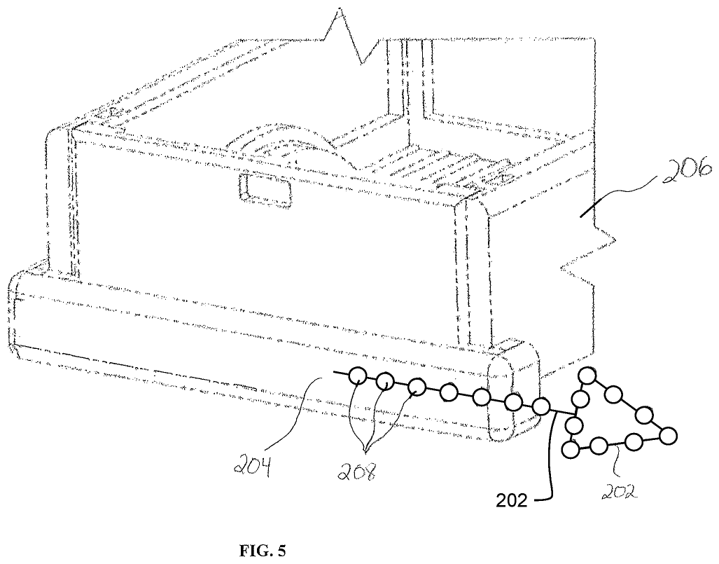

Referring to FIG. 2, a portable lighted warning arrow 200 preferably comprises an elongated magnetic rod 202 configured for movable magnetic attachment 203 to a metal surface 204 of a vehicle 206, said magnetic rod 202 forming a shape of an arrow, for example, for the direction of oncoming traffic relative to the vehicle 206. A person having the ordinary skill in the art will appreciate that various alternative shapes may be useful. Preferably, the warning arrow 200 includes a plurality of light emitting diodes 208 electrically connected via wiring 210, for example, to a portable power source 212. Preferably, the rod 202 may be configured in the shape of an arrow for directing oncoming traffic away from the vehicle 206 as shown in FIG. 4A, for example. Referring to FIG. 4B, in one embodiment, the warning arrow 200 forms the shape of an arrow comprising the shape of a double headed arrow 207 having a first head opposite a second head. In an embodiment, elongated magnetic rod 202 is configured to cantilever outwardly, as show in FIG. 5 from said magnetic attachment to the vehicle 206. Preferably, a battery 214 electrically connected to said LEDs 208. In some embodiments, alternative power sources, such as power from the vehicle 206, may be used to power the portable lighted warning arrow 200. A switch 216 may be electrically interposed between said battery 214 and said LEDs 208 for powering of said LEDs 208 at the option of the user.

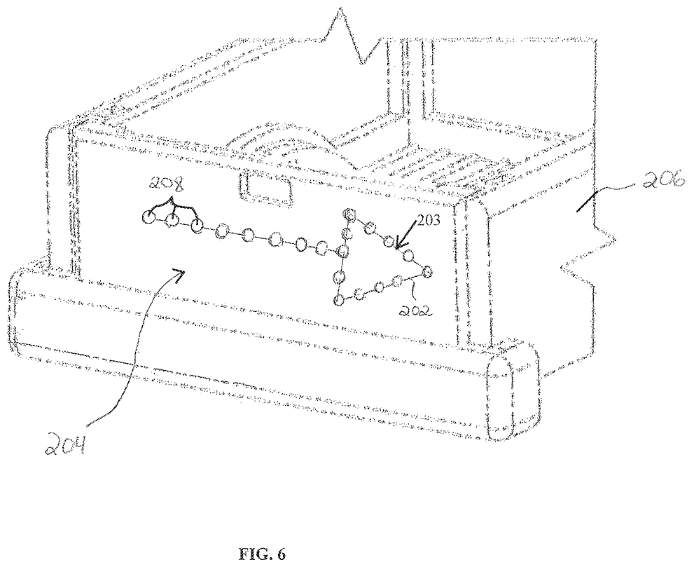

Referring to FIGS. 6-8, a flexible emergency sign 300 for application to a surface of a vehicle 306 is disclosed. In a preferred embodiment, a flexible magnetic substrate 302 may include an arrangement of light emitting diodes 308 configured in the shape of an arrow. Preferably, a battery 314 may be secured to an underside 318 of the flexible magnetic substrate 302. In some embodiments, a switch 316 may be electrically interposed by a wire 317, for example, between a terminal 320 which is preferably arranged to couple to the battery 314 and the LEDs 308. Preferably, a periodic interruption circuit 322 may be arranged to discontinue the flow of electrical energy from the battery 314 to the LEDs 308 periodically so as to produce a flashing effect characterized as the shape of a moving arrow, for example. Alternative configurations may be arranged to produce a variety of desired visual effects. In a preferred embodiment, the sign 300 may be molded and preferably is of substantially rigid, yet somewhat pliable plastic material of a thickness, which is thin for signs of such material, that is of between one-thirty-seconds and one-sixteenths inch, and with the overall area being of a height of at least about 8 to 10 inches and the base being of about 10 to 12 inches. Preferably, the material of the sign is polypropylene of the class which does not substantially soften except about 120 degrees F. The flexible magnetic substrate 302 may be composed of a particulate ferromagnetic body formed of a metallic oxide such as barium ferrite or the like and a mixture of rubber or plastic containing small quantities of compounds such as plasticizers, stabilizers, or the like, for example.

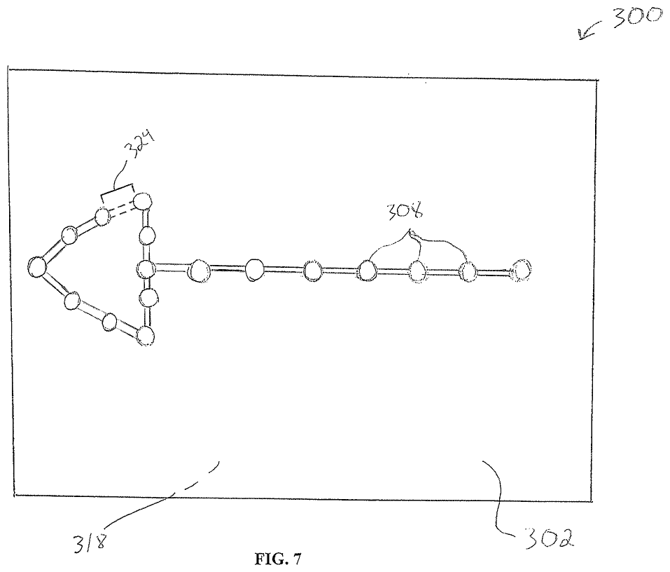

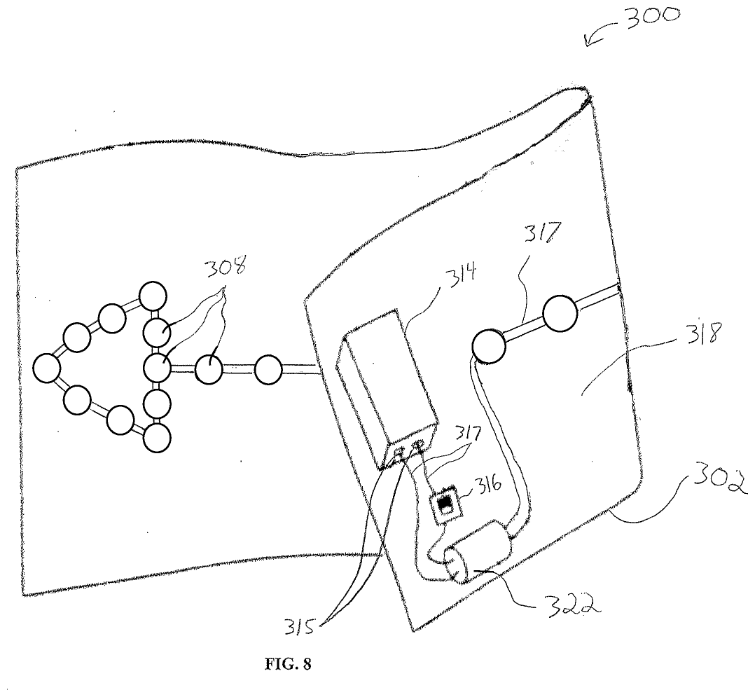

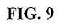

Referring to FIG. 8, switch 316 may be electrically interposed between terminal 320, which is preferably arranged to be couplable to the battery 314, and the LEDs. Switch 316 may be of any of several known types, including sliding, toggle, and push-button type switches. In another embodiment, a battery is electronically connected to the LEDs, and the switch 316 preferably includes the surface 104, 204, 304 of the vehicle, such that the magnetic adherence to the surface 104, 204, 304 of the vehicle 106, 206, 306 continues the flow 324 of electrical energy from the battery (e.g., 314) to the LEDs (e.g., 308), to power the LEDs by completing the exemplary circuit at 324 as illustrated in FIG. 7.

In the specific illustrative embodiment of FIG. 8, the periodic interruption circuit 322 is electrically interposed between the battery terminals 315 and the LEDs 308. Periodic interruption circuit 322 is preferably arranged to discontinue the flow of electrical energy from the battery 314 to the LEDs 308 periodically so as to produce a flashing effect. Thus, in addition to reducing the overall consumption of electric energy by the LEDs, the resulting flashing of the LEDs enhances the ability of the display to attract the attention of a person to whom the message is directed. Periodic interruption circuit 322 is preferably of a known type and may be for example, an astable multivibrator circuit, of the type which is readily available. In the present embodiment, therefore, when switch 316 is closed so as to provide electrical energy to periodic interruption circuit 322, the periodic interruption circuit 322 will provide a periodic voltage between flexible electrical conductors (i.e., wire) 317, allowing for flashing of the LEDs 308 providing illuminating warning to oncoming traffic in the shape of the arrow as then configured, for example, when held magnetically attached to a stalled vehicle (e.g., 106, 206, 306). In a practical embodiment of the invention, the voltage between flexible electrical conductors 317 has a substantially rectangular wave form.

The LEDs 108, 208, and 308 shown in the Figures are preferably electrically connected to a power supply, such as a DC power supply or an AC outlet, by a power cord or electrical wire 117, 217, and 317. In a preferred embodiment, the LEDs 108, 208, and 308 are electrically connected to a battery 314, as illustrated, for example, in FIG. 8. In another embodiment, the flexible emergency sign 100 is configured such that the LEDs 108, 208, and 308 may be electrically connected to an accessory power outlet of an automobile, such as a cigarette lighter socket.

All U.S. patents and publications identified herein are incorporated in their entirety by reference thereto.

The claimed invention is:

1. A lighted arrow sign for removable attachment to a surface of a vehicle, comprising:
an elongated magnetic plate member for removable magnetic adherence to the surface of the vehicle, said elongated magnetic plate member forming a shape of a double-headed arrow having a first magnetic arrowhead disposed opposite a second magnetic arrowhead, each magnetic arrowhead magnetically attachable to the surface of the vehicle;
said elongated magnetic plate member comprising a plurality of light emitting diodes configured to display the shape of the double-headed arrow for the direction of oncoming traffic relative to the vehicle when at least a portion of the first or second magnetic arrowhead of said double-headed arrow is magnetically connected to the surface of the vehicle.

2. The lighted arrow sign of claim 1, wherein the elongated magnetic plate member is characterized as portable in size and configured to be grasped by a user's hand to maneuver and position said lighted arrow sign upon the surface of the vehicle.

3. The lighted arrow sign of claim 1, wherein the elongated magnetic plate member is characterized as having a length sufficient to extend laterally outwardly from said vehicle to form a cantilever, when the first magnetic arrowhead or the second magnetic arrowhead is magnetically attached directly to the surface of the vehicle, wherein said cantilever directs oncoming traffic away from said vehicle.

4. The lighted arrow sign of claim 1, further comprising a battery and a switch electrically interposed between said battery and said LEDs for powering of said LEDs at the option of a user.

5. The lighted arrow sign of claim 4, wherein the switch comprises the surface of the vehicle, wherein said magnetic adherence to said surface of the vehicle continues flow of electrical energy through the surface of the vehicle from the battery to the LEDs.

6. The lighted arrow sign of claim 1, further comprising a periodic interruption circuit arranged to discontinue the flow of electrical energy from a battery to the LEDs periodically so as to produce a flashing effect characterized as illustrating the shape of an arrow.

7. The lighted arrow sign of claim 1, further comprising a periodic interruption circuit arranged to discontinue the flow of electrical energy from a battery to the LEDs periodically so as to produce a flashing effect characterized as a moving arrow.

8. The lighted arrow sign of claim 1, further comprising a battery and a switch electrically interposed between said battery and said LEDs, wherein the switch comprises the surface of the vehicle, wherein magnetic adherence of the first magnetic arrowhead or the second magnetic arrowhead to the surface of the vehicle continues flow of electrical energy through the surface of the vehicle from the battery to the LEDs for powering of said LEDs at the option of the user.

9. A portable lighted warning arrow comprising:
an elongated magnetic rod configured for removable magnetic attachment to a metal surface of a vehicle, said elongated magnetic rod comprising a first end outlining a first magnetic triangle opposite a second end outlining a second magnetic triangle, and an elongated magnetic member connecting said first magnetic triangle to the second magnetic triangle for the direction of oncoming traffic relative to the vehicle, said first magnetic triangle, second magnetic triangle, and elongated magnetic member each comprising a plurality of light emitting diodes electrically connected to a portable power source, wherein said elongated magnetic rod is configured to cantilever outwardly from the first magnetic triangle or the second magnetic triangle;
a battery electrically connected to said LEDs; and
a switch electrically interposed between said battery and said LEDs for powering of said LEDs at the option of a user.

10. The portable lighted warning arrow of claim 9, wherein the elongated magnetic rod is characterized as portable in size and configured to be grasped by the user's hand to maneuver and position said warning arrow upon the surface of the vehicle.

11. The portable lighted warning arrow of claim 9, further comprising a periodic interruption circuit arranged to discontinue the flow of electrical energy from the battery to the LEDs periodically so as to produce a flashing effect characterized as illustrating a shape of a warning arrow.

12. The portable lighted warning arrow of claim 9, wherein the switch is disposed within a portion of either the first or second magnetic triangle, wherein magnetic attachment of the first or second magnetic triangle to said metal surface of the vehicle continues flow of electrical energy from the battery to the LEDs.

13. The portable lighted warning arrow of claim 9, wherein the switch comprises the metal surface of the vehicle, wherein said magnetic attachment to said metal surface of the vehicle continues flow of electrical energy from the battery to the LEDs.

14. A flexible emergency sign for application to a surface of a vehicle, comprising:
a flexible magnetic substrate comprising an arrangement of light emitting diodes (LEDs) embedded within the flexible magnetic substrate and configured in a shape of an arrow, said LEDs adapted to emit light through the flexible magnetic substrate;
a battery secured to the flexible magnetic substrate; and
a switch electrically interposed between the battery and the LEDs.

15. The flexible emergency sign of claim 14, further comprising a periodic interruption circuit electrically arranged to discontinue the flow of electrical energy from the battery to the LEDs periodically so as to produce a flashing effect characterized as illustrating the shape of an arrow.

16. The flexible emergency sign of claim 14, further comprising a periodic interruption circuit electrically arranged to discontinue the flow of electrical energy from the battery to the LEDs periodically so as to produce a flashing effect characterized as illustrating the shape of a moving arrow.

17. The flexible emergency sign of claim 14, wherein the shape of the arrow comprises the shape of a double headed arrow having a first head opposite a second head.

18. The flexible emergency sign of claim 14, wherein the switch comprises at least a portion of a metal surface of the vehicle, wherein magnetic attachment of the flexible magnetic substrate to said metal surface of the vehicle continues flow of electrical energy from the battery to the LEDs to power the LEDs.

19. The flexible emergency sign of claim 14, wherein the surface of the vehicle is curved, said flexible magnetic substrate configured to magnetically attach and conform to said curved surface, at the option of the user.
